(19) United States
(12) Patent Application Publication
(10) Pub. No.: US 2008/0104621 A1
(43) Pub. Date: May 1, 2008

(54) Optical disc apparatus

(75) Inventor: Toshiaki Takada, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/978,613

(22) Filed: Oct. 30, 2007

(30) Foreign Application Priority Data
Oct. 31, 2006 (JP) 2006-297141

(51) Int. Cl. G11B 33/12

(52) U.S. Cl. 720/652

(57) ABSTRACT

According to one embodiment, an optical disc apparatus is configured to prevent a flexible wiring material from contacting a cover member used for an optical disc in a sliding state, and reduce a temperature increase of a laser-emitting element caused by heat from a laser-emitting element provided in the pickup unit, by increasing the radius of curvature of a flexible wiring material connected to a pickup unit when the pickup unit holding an objective lens movably is moved along the radius direction of an optical disc.

### CROSS-REFERENCE TO RELATED APPLICATIONS

This application is based upon and claims the benefit of priority from Japanese Patent Application No. 2006-297141, filed Oct. 31, 2006, the entire contents of which are incorporated herein by reference.

### BACKGROUND

1. Field

One embodiment of the present invention relates to a signal wire connection structure of an optical pickup unit, and an optical disc apparatus.

2. Description of the Related Art

A long time has been passed since practical use of an optical disc apparatus that is an apparatus handling an optical disc capable of reproducing prerecorded information by using a laser beam, or recording information by a laser beam.

An optical disc includes an optical pickup (optical head) unit which moves radially relative to an information recording surface of an optical disc, and reads information recorded in an optical disc or records information in an optical disc, an optical head feeding mechanism for moving an optical pickup unit radially relative to an optical disc, and a control circuit for controlling a series of operations for recording and reproducing information. A flexible wiring material is used to electrically connect the control circuit and optical pickup unit mounted on a drawer chassis (signal conductor between the optical pickup unit and a frame) for transmitting a reproducing signal obtained by the optical pickup unit or a recording signal recorded by the optical pickup unit.

The flexible wiring material is given a predetermined length not to limit movement of the optical pickup unit in all areas where the optical pickup unit is moved radially. Therefore, as the optical pickup unit comes close to the position where the flexible wiring material is bent most, the bending of the flexible wiring material provided in the state usually folded by 180°, or a radius of curvature of the folded portion is increased. Particularly, as the flexible wiring material generally has a certain degree of hardness, when the radius of curvature of the folded portion of the flexible wiring material increases, the folded portion of the flexible wiring material is pressed by a bottom plate of a main unit in a thin optical disc drive. Thus, the side of the optical disc opposite to the bottom plate of the flexible wiring material of the folded portion comes into contact with the optical disc surface. In order to avoid this problem, a cover member is provided to prevent the contact between the optical disc and the folded portion of the flexible wiring material.

However, it is known that the flexible wiring material moves and contacts the cover member while changing the radius of curvature even if a cover member is provided, and the flexible wiring material is gradually worn.

In the circumstances, for example, Japanese Patent Application Publication (KOKAI) No. 2000-251421 proposes to avoid contacting of a folded loop of a flexible wiring plate with a cover plate (cover member) by tapering a corner of an optical head unit through which a flexible wiring plate is pulled out.

However, in the optical head unit described in the above document, the distance between the cover plate and the folded loop of the flexible wiring plate is easily ensured, but the contact between the both, or the possibility of contacting the flexible wiring plate with the cover plate is not completely eliminated. Further, when the flexible wiring plate comes into contact with the cover plate, it attains a sliding state (the contacting position always changes), and the flexible wiring plate will be worn sooner.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus according to an embodiment of the invention;

FIG. 2 is an exemplary diagram showing an example of the optical disc apparatus shown in FIG. 1, according to an embodiment of the invention, with a drawer unit removed and a drawer chassis/chassis base separated;

FIG. 3 is an exemplary diagram showing examples of bending of a flexible wiring material and projection of a bent portion in a drawer chassis/chassis base of the optical disc apparatus shown in FIG. 1, according to an embodiment of the invention;

FIG. 4 is an exemplary diagram showing examples of a change in the radius of curvature of a bent portion of an optical pickup of a flexible wiring material for electrically connecting an optical pickup (actuator) and a chassis base (drawer chassis), with respect to movement of an optical pickup, in the optical disc apparatus shown in FIGS. 1 to 3, according to embodiment of the invention;

FIG. 5 is an exemplary diagram showing an example of a change in the radius of curvature of a bent portion of an optical pickup of a flexible wiring material for electrically connecting an optical pickup (actuator) and a chassis base (drawer chassis), with respect to movement of an optical pickup, in the optical disc apparatus shown in FIG. 4, according to embodiment of the invention;

FIG. 6 is an exemplary diagram showing an example of a guide plate of the optical disc apparatus shown in FIG. 2 or 4, according to an embodiment of the invention;

FIG. 7 is an exemplary diagram showing an example of a cover of the optical disc apparatus shown in FIG. 1 or 2, according to an embodiment of the invention;

FIG. 8 is a graph showing improvement of a cooling capacity by using a cover in the optical disc apparatus shown in any one of FIG. 1, 2 or 7, according to an embodiment of the invention; and

FIG. 9 is an exemplary block diagram showing a control system of an optical disc apparatus provided with an optical pickup unit, according to an embodiment of the invention.

### DETAILED DESCRIPTION

Various embodiments according to the invention will be described hereinafter with reference to the accompanying drawings. In general, according to one embodiment of the invention, an optical disc apparatus is configured to prevent a flexible wiring material from contacting a cover member used for an optical disc in a sliding state, and reduce a temperature increase of a laser-emitting element caused by heat from a laser-emitting element provided in the pickup unit, by increasing the radius of curvature of a flexible wiring material connected to a pickup unit when the pickup unit holding an objective lens movably is moved along the radius direction of an optical disc.

According to an embodiment of this invention relates to a signal wire connection structure of an optical pickup unit and an optical disc apparatus, which avoids wearing of a flexible wiring material caused by contacting a cover member, and reduces apparatus costs.

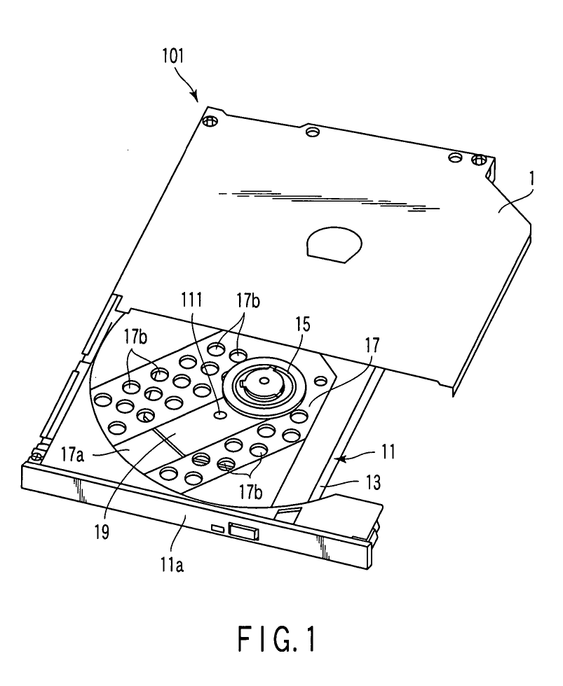

FIG. 1 shows an example of an optical disc apparatus according to an embodiment of the invention. The optical disc apparatus shown in FIG. 1 is called a drawer type, in which a disc tray holding an optical disc is projected from a housing 1, and is used in being incorporated in a personal computer, for example.

The optical disc apparatus 101 shown in FIG. 1 has a housing 1, and a drawer unit 11 housed in the housing 1 and projected from the housing 1 when mounting or removing an optical disc as a recording medium. FIG. 1 shows the drawer unit 11 released (projected) from the housing 1.

The drawer unit 11 has a drawer chassis/chassis base 13.

At a predetermined position of the drawer chassis/chassis base 13, there is fixed a disc motor having a turntable 15 to hold and turn an optical disc at a specified speed. In the end portion of the side of the drawer chassis-chassis base 13 opposite to the turntable 15, there is provided a control circuit 14 for controlling rotation of a disc motor not described in detail of the turntable 15 and a head feeding mechanism explained later, for example.

Most parts of the drawer chassis/chassis base 13, including the area around the disc motor, are covered by a cover 17 having a partially cut out opening 17a. As explained later with reference to FIG. 3 (not seen in FIG. 1), in the side opposite to the side that the turntable 15 is exposed, a rear cover 21 is provided to cover all areas or a part of the rear side of the drawer chassis/chassis base 13.

An objective lens 111 is exposed in the opening (cutout) 17a of the cover 17. The objective lens is swingable and provided at a predetermined position of an optical pickup head (PUH) 19 for reading information from an optical disc mounted on the turntable 15. The motion of the objective lens 111 is controlled in the focusing direction (optical axis direction of a laser beam) and in the tracking direction (radially relative to an optical disc), so as to condense a laser beam on the information recording surface of an optical disc by an actuator driving coil (not-shown) provided in an actuator mechanism provided in the PUH 19.

The cover 17 is formed with radiating holes 17b to escape inside heat, in addition to the opening (cutout) 17a. By providing the radiating holes 17b, when an optical disc is set on the turntable 15 and rotated, airflow is produced around the PUH 19. Therefore, the temperature of the PUH 19 heated by the laser-emitting element and actuator driving coil provided in the PUH 19 is decreased, and as a result, the temperature rise of the laser-emitting element can be reduced (the airflow produced by the rotation of a disc can be used to cool the laser-emitting element). The shape of the radiating hole is not limited to circular shown in the drawing, and may be a circle concentric with the center of rotation of the turntable 15, or may be linear parallel or orthogonal to the direction of projecting the drawer chassis/chassis base 13 from the housing 1. The radiating holes 17b for escaping internal heat may be provided to prevent wearing of a flexible wiring material 29 described later, by providing a guide plate 31 described later.

The PUH 19 is movable between the turntable 15 and the distal end portion 11a in the direction of projecting the drawer unit 11, that is, radially relative to a disc when an optical disc is mounted on the turntable 15. The PUH 19 has the above-mentioned objective lens 111, which irradiates a laser beam with a predetermined wavelength to the information recording surface of an optical disc, and takes in a reflected laser beam reflected on the information recording surface of an optical disc, though not described in detail.

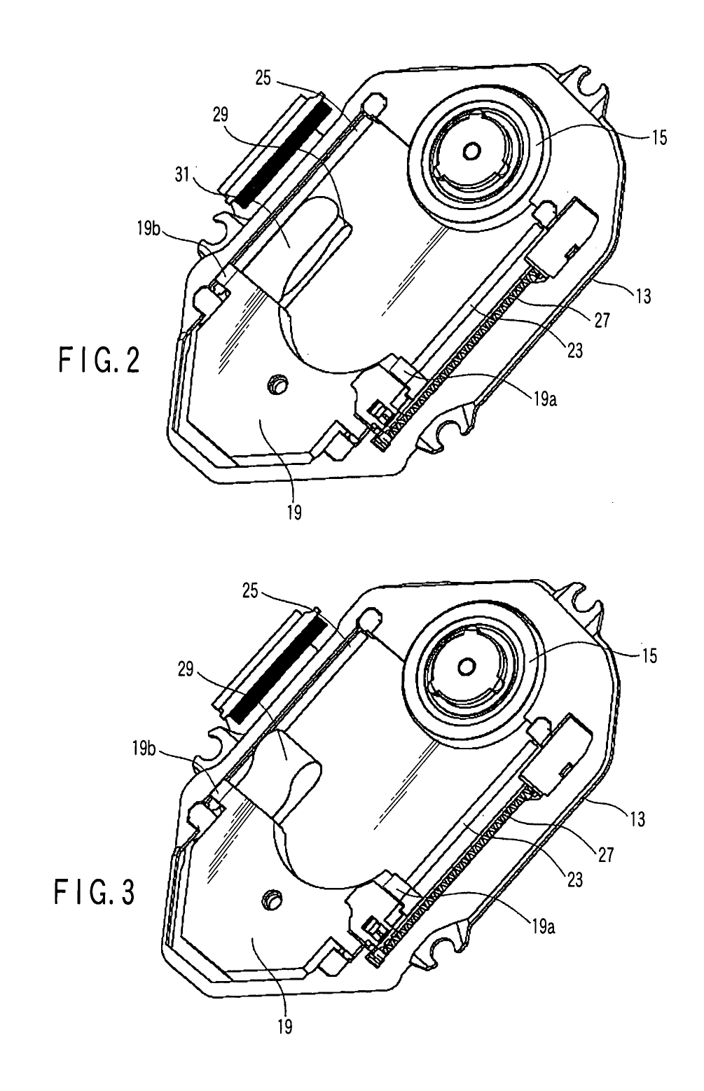

FIGS. 2 and 3 show the states that drawer unit 11 is removed from the housing 1 of the optical disc apparatus 101 shown in FIG. 1, and the drawer chassis/chassis base 13 is separated. In FIGS. 2 and 3, the cover 17 is also removed.

At predetermined positions of the drawer chassis/chassis base 13, there are provided a guide rod 23 and a guide rail 25, which movably support the PUH 19 between the position of reading data on the inner tracks of a disc close to the turntable 15 and the position of reading data on the outer tracks where the distance from the turntable 15 is secured most.

The guide rod 23 and guide rail 25 are positioned on both sides of the turntable 15 along a line segment including the center of rotation of the turntable 15 as a centerline. A head feeding mechanism 27 is provided to move the PUH 19 substantially parallel to the guide rod between the position of reading the data on the inner tracks of a disc and the position of reading data on the outer tracks. The head feeding mechanism 27 is mechanically combined with the PUH 19 at a predetermined position of the PUH 19, and moves the PUH 19 between the position of reading the data on the inner tracks and the position of reading data on the outer tracks, by transmitting a driving force supplied from the head feeding mechanism 27, though not described in detail.

The guide rod 23 serves also for positioning for moving the PUH 19 radially substantially parallel to the information recording surface of an optical disc, by being inserted into a rod receiver 19a of the PUH 19. The guide rail 25 is given a shape capable of sliding a projection or a contactor 19b of the PUH 19, and provided substantially parallel to the guide rod 23. The guide rail may be shaped like a rod like the guide rod 23.

Smooth movement of the PUH 19 radially relative to a disc mounted on the turntable 15 is ensured by being movably held by the guide rod 23 and guide rail 25.

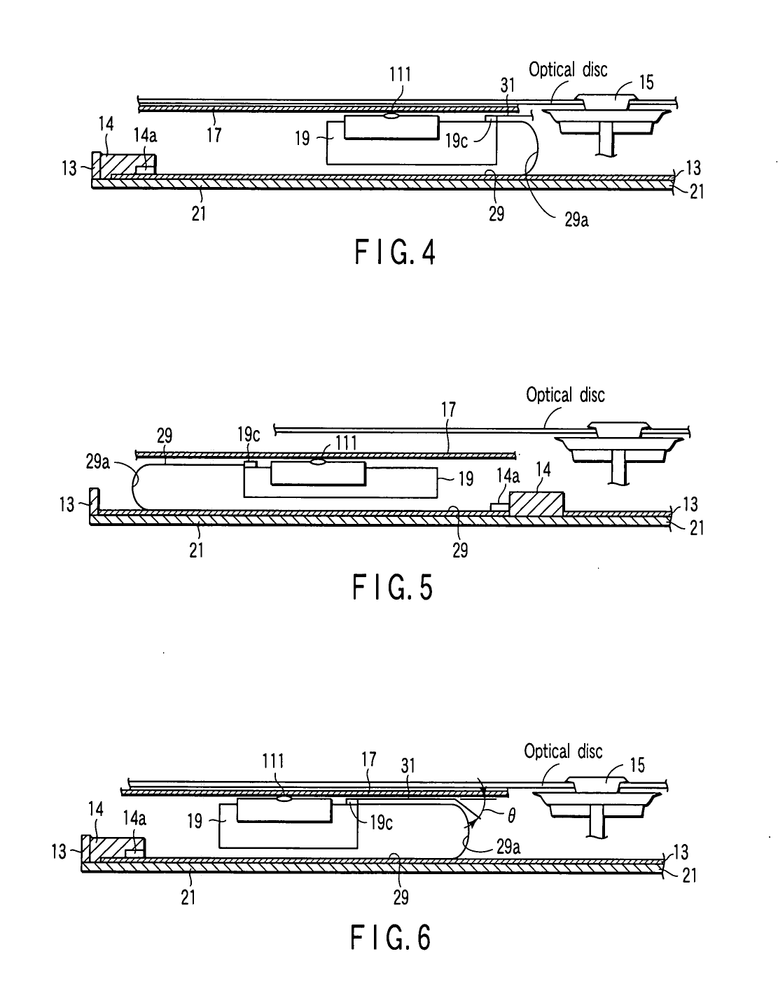

In an area close to the contactor 19b of the PUH 19, there is prepared a connection terminal 19c (FIG. 4) that is used for electrical connection between the PUH 19 and the connection terminal 14a (FIG. 4) of the control circuit 14 provided on the chassis base 13.

A flexible wiring material 29 is used between the connection terminal 14a and connection terminal 19c. Namely, the PUH 19 and chassis base 13 are electrically connected by the flexible wiring material 29. Generally, the electrical wiring of the laser-emitting element and the actuator driving coil in the PUH 19 is included in the flexible wiring material 29.

As shown in FIG. 4, when the flexible wiring material 29 comes into contact with the rear cover 21 exposed from a not-shown opening of the chassis base 13, an increment of the radius of curvature of its bending portion is concentrated to the optical disc set on the turntable 15, or the cover 17. Therefore, as shown in FIG. 3, when the guide shown in FIG. 2 is removed, the bending portion 29a of the flexible wiring material 29 is projected by repulsion (pressing force) from the rear cover 21.

Therefore, the flexible wiring material 29 is prevented from contacting the cover 17, by preventing the increment of the radius of curvature of the bending portion of the flexible wiring material 29 from appearing (FIG. 2) in the cover 17 (FIG. 1) when the PUH 19 is moved, by providing the guide plate 31 at a predetermined position of the PUH 19.

The flexible wiring material 29 is connected to the connection terminal 19c (FIG. 4) provided in the upper end side in the thickness direction of the PUH 19, reversed in the direction with the bending portion (portion to be deformed when the PUH 19 moves) 29a facing the turntable 15, guided along the bottom (on the rear cover 21) of the PUH 19, and connected to the chassis base 13 (connection terminal 14a).

As shown in FIG. 1, the cover 17 has radiating holes 17b, but the cover 17 is prevented from contacting the flexible wiring material 29 by the guide plate 31, and the flexible wiring material 29 is not worn. The flexible wiring material 29 contacts the guide plate 31 and rear cover 21 in this embodiment, but the guide plate 31 moves as one body with the PUH 19 when the PUH 19 moves, and the flexible wiring material 29 and guide plate 31 don't contact in a sliding state. Even when the rear cover 21 contacts the flexible wiring material 29, they don't contact in a sliding state. Namely, when the flexible wiring material 29 contacts the guide plate 31 or rear cover 21, they merely contact at the same position just like rolling to a specific position in the guide plate 31 or rear cover 21. Therefore, the flexible wiring material 29 is worn very little, the wear being substantially negligible.

The guide plate 31 has a possibility of interfering with a part or a circuit element provided on the chassis base 13, when the PUH 19 is moved closest to the turntable 15. Therefore, it is preferable to make the thickness of the guide plate partially thin in the part close to the turntable 15 where the guide plate 31 is positioned as a result of moving the PUH 19.

FIG. 5 shows an example that the contact terminals of the PUH 19 and control circuit 14 provided on the chassis base 13 are reversed, that is, the flexible wiring material 29 is connected to the connection terminal 19c in the end portion of the PUH 19 separated from the turntable 15, and connected to the connection terminal 14a of the chassis base 13 in the part close to the turntable 15. Namely, the flexible wiring material 29 is reversed in the direction with the bending portion (portion to be deformed when the PUH 19 moves) facing the opposite side of the turntable 15, guided along the bottom (on the rear cover 21) of the PUH 19, and connected to the connection terminal 14a close to the turntable 15 of the chassis base 13. In the example shown in FIG. 4, an increment of the radius of curvature of the bending portion of the flexible wiring material 29 produced by the movement of the PUH 19 is prevented from appearing in the cover 17 and rear cover 21.

In the example shown in FIG. 5, the bending portion 29a of the flexible wiring material 29 becomes maximum when the PUH 19 is moved to the above-mentioned position of reading data on internal tracks, and becomes minimum when the PUH 19 is moved to the above-mentioned position of reading data on outer tracks. However, by providing the guide plate 31, an increment of the radius of curvature of the bending portion of the flexible wiring material 29 itself is concentrated to the space between the cover 17 and rear cover 21.

The guide plate 31 may be given a predetermined angle θ toward the flexible wiring material 29, as shown in FIG. 6, so that the side (distal end portion) separated from the PUH 19 suppresses an increase in the radius of curvature of the bending portion of the flexible wiring material 29. In this case, the length of the part of the guide plate 31 extending from the PUH 19 can be reduced, compared with the example explained with reference to FIG. 1 or 4.

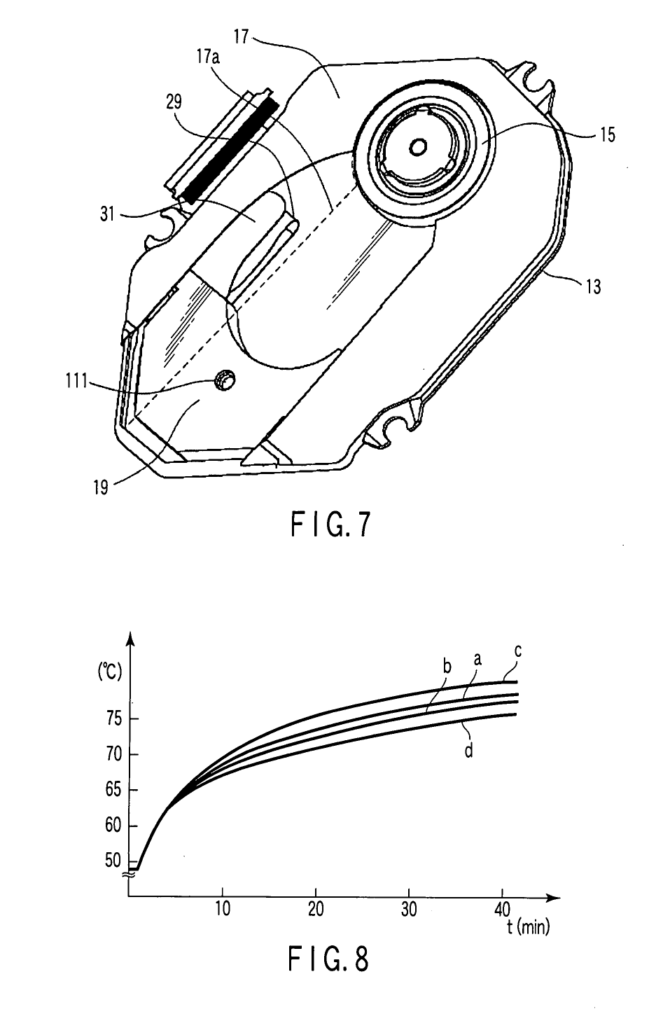

The inside heat can be escaped more efficiently, by increasing the size of the opening 17a of the cover 17 shown in FIG. 1, as shown in FIG. 7.

Even in a slot-in type that the drawer unit 11 is not projected from a housing 1, the information recording surface of an optical disc mounted on the turntable 15 can be prevented from contacting the flexible wiring material 29 by providing the guide plate 31, and the cover 17 can be removed. In this case, the temperature increase of the PUH 19 is reduced by the heat from the laser-emitting element and actuator driving coil provided in the PUH 19, and as a result, the temperature increase of the laser-emitting element is reduced (the flow of air generated by the rotation of a disc can be used for cooling the laser-emitting element).

FIG. 8 shows the degree of temperature increase around the PUH (actuator) when using a cover with increased radiation efficiency shown in FIG. 1 or 7. In most optical discs, X2 (double speed) writing is possible. That is, when a recordable time of a disc is 74 minutes, the time required for recording is usually about 40 minutes. Therefore, the temperature increase is defined for data of up to 40 minutes.

In FIG. 8, curve a indicates the degree of temperature increase when using a cover increased in the size of the opening shown in FIG. 7. Curve b indicates the degree of temperature increase when using a cover having radiating holes shown in FIG. 1. Curve c indicates the case when using a standard shape cover having no openings unlike the cover shown in FIG. 1 (before embodying the sample) (for comparing the temperature increase). Curve d indicates the case when no cover is used in a slot-in type.

It is seen from FIG. 8 that a temperature is decreased by about 2° C. (the cooling capacity is increased) (curve a) by increasing the area of the opening of the cover (example of FIG. 7). It is also seen (curve b) that a temperature is decreased by about 1.5° C. by providing radiating holes in the cover (from the example of FIG. 1). Further, a temperature is decreased by about 5° C. (curve d) by removing the cover, thought this is applicable only to the slot-in type.

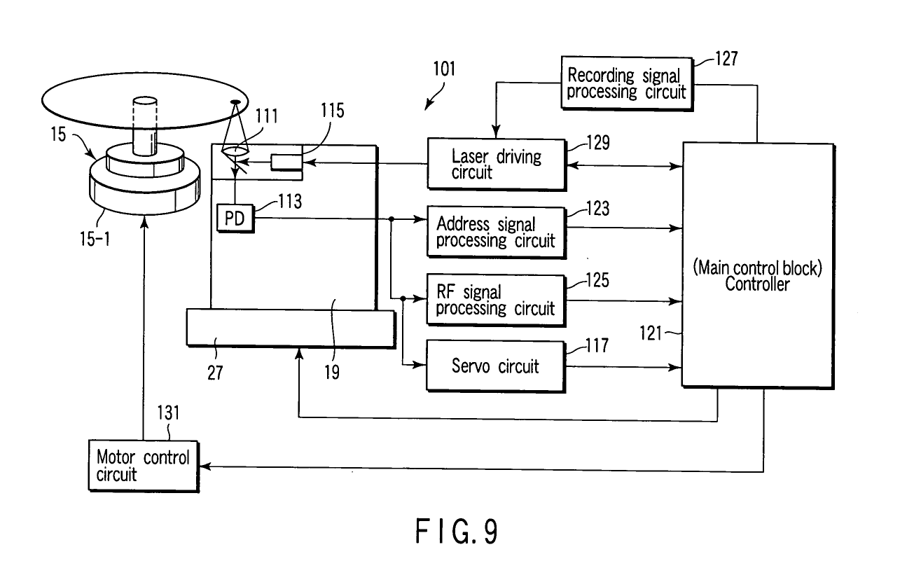

FIG. 9 shows an example of the control system of the control circuit of the optical disc apparatus shown in FIGS. 1 to 7.

As shown in FIG. 9, an optical disc apparatus 101 receives a reflected laser beam from an optical disc obtained by irradiating a laser beam with a predetermined wavelength emitted from a laser-emitting element (LD) 115 provided at a predetermined position of the PUH 19, on the information recording surface of an optical disc by using an objective lens 111, and gains an electric signal corresponding to the intensity of the reflected laser beam by a photodetector (photodetector IC [PDIC]) 113.

The output from the PDIC 113 is controlled by a controller (main control block) 121, and used for calculation of a track or record mark line being lit by a laser beam, in an address signal processing circuit 123, for example. The output from the PDIC 113 is reproduced by a RF signal processing circuit 125, as information recorded on an optical disc.

When recording information on an optical disc, the controller 121 functions, and a recording signal (laser driving signal) corresponding to the data to be recorded is generated in the recording signal processing circuit 127, and supplied to the laser driving circuit (LDD) 129. Therefore, a laser beam with a predetermined wavelength is emitted from the laser-emitting element 115, condensed on the information recording surface of an optical disc by the objective lens 111, and a laser beam of a predetermined spot size is irradiated. The laser intensity can be optionally changed at the time of reproducing, recording, and erasing.

Based on the address signal processing circuit 123, a predetermined amount of control is supplied to the head feeding mechanism 27, and the PUH 19 is moved radially relative to an optical disc. A speed of moving a track or record mark line on the information recording surface of an optical disc is set to a predetermined speed by changing a control amount supplied from the motor control circuit 131 to the disc motor 15-1 to turn the turntable 15.

A part of the output from the PDIC 113 is supplied to a servo circuit 117 to change the position of the objective lens 111 in a stage before supplying to the RF signal processing circuit 125, and used to correct a distance from an optical disc to the information recording surface (focus error), a displacement from the center of the track or record mark line radially relative to an optical disc (tracking error), and a periodical fluctuation of the information recording surface of an optical disc generated (tilt error) when an optical disc is rotated, by controlling the driving current supplied to a not-shown actuator driving coil for driving the objective lens 111 in the focusing direction and in the tracking direction of an optical disc.

As explained hereinbefore, according to an embodiment of the invention, the flexible wiring material electrically connecting the optical pickup unit and the control circuit mounted on the chassis base (drawer chassis) does not come into contact with the cover member preventing the flexible wiring material from contacting an optical disc.

By using a material with good thermal conductivity as a guide member and thermally coupling it with the optical pickup unit, or by providing it as one body with the metallic cover of the optical pickup, the guide member can serve as a radiator plate, and the temperature increase of the laser-emitting element by the heat from the laser-emitting element provided in the optical pickup unit can be decreased. As a result, the life of the laser-emitting element can be increased.

Further, as a protection sheet to be stuck to the cover member at the position where the cover member contacts the flexible wiring material for preventing friction of the flexible wiring material becomes unnecessary, the number of parts can be decreased, the number of man-hours can be decreased, and the weight can be reduced. As a result, the production cost and parts cost can be reduced.

Therefore, it is possible to provide a signal transmission wire connection structure and an optical disc apparatus, which can control wearing of a flexible wiring material caused by contacting a cover member, and can reduce the parts and apparatus costs.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a support block which supports a laser-emitting element to emit a laser beam for at least recording and reproducing information on/from an information recording surface of an optical disc, and an objective lens for condensing the laser beam on the information recording surface of the optical disc;
a baser member which holds the support block;
a connection terminal, defined at a predetermined position of the support block, which electrically connects an electrical port of the support block;
a connection terminal, defined at a predetermined position of the base member, which electrically connects an electrical port of the base member;
a signal transmission wire, has flexibility, which electrically connects the two connection terminals; and
a guide member, provided as one body with the support block, which determines a direction of deforming a wiring material of the signal transmission wire when the wiring material is deformed by movement of the support block.

2. The optical disc apparatus according to claim 1, wherein the guide member determines the deforming direction to a direction of preventing the signal transmission wire from extending in a direction of bending and coming into contact with an optical disc.

3. The optical disc apparatus according to claim 2, wherein the guide member is deformed in a direction of preventing the signal transmission wire from contacting an optical disc, in a direction of separating from an optical disc.

4. An optical disc apparatus comprising:
a support block which swingably supports a laser-emitting element to emit a laser beam for at least recording and reproducing information on/from an information recording surface of an optical disc, and an objective lens which condenses the laser beam on the information recording surface of the optical disc;
a baser member which holds the support block;
a connection terminal, defined at a predetermined position of the support block, which electrically connects an electrical port of the support block;
a connection terminal, defined at a predetermined position of the base member, which electrically connects an electrical port of the base member;
a signal transmission wire, has flexibility, which electrically connects the two connection terminals;
a guide member, provided as one body with the support block, which determines a direction of deforming a wiring material of the signal transmission wire when the wiring material is deformed by movement of the support block; and
a cover member which covers a part of the support block and the signal transmission wire, and has an opening to permit passage of airflow for cooling the support block.

5. The optical disc apparatus according to claim 4, wherein the cover member has holes.

6. The optical disc apparatus according to claim 4, wherein the cover member is given an opening with an area larger than a range of exposing the objective lens supported by the support block.

7. The optical disc apparatus according to claim 4, wherein the cover member is provided in a state that the guide member is positioned between the support block and signal transmission wire.

8. An optical disc apparatus comprising:
a support block which swingably supports a laser-emitting element to emit a laser beam for at least recording and reproducing information on/from an information recording surface of an optical disc, and an objective lens for condensing the laser beam on the information recording surface of the optical disc;
a connection terminal, defined at a predetermined position of the support block, which electrically connects an electrical port of the support block;
a signal transmission wire, has flexibility, which supplies a signal to the connection terminal; and
a guide member, provided as one body with the support block, which determines a direction of deforming a wiring material of the signal transmission wire when the wiring material is deformed by movement of the support block.

9. The optical disc apparatus according to claim 8, wherein the guide member determines a direction of deforming the signal transmission wire to a predetermined direction, when the support block is moved in a predetermined direction.
